(19) United States
(12) Patent Application Publication
(10) Pub. No.: US 2023/0128533 A1
(43) Pub. Date: Apr. 27, 2023

(54) HIGH EFFICIENCY OVEN CAVITY VENTILATION SYSTEMS AND METHODS

(71) Applicant: WHIRLPOOL CORPORATION, Benton Harbor, MI (US)

(72) Inventors: Federico GARUCCIO, Bresso (IT); Louis LIU, Guangdong (CN); Dheeraj Nandkishor MALEWADKAR, Pune (IN); Brijesh Kumar PANDEY, Pirpainti (IN); Jeevan Madhukar YADAV, Pune (IN); Luca ZILIO, Biandronno (IT)

(21) Appl. No.: 17/967,205

(22) Filed: Oct. 17, 2022

(30) Foreign Application Priority Data
Oct. 21, 2021 (CN) 202111226996.4

(51) Int. Cl. F24C 15/32; F24C 15/00

(52) U.S. Cl. CPC F24C 15/322; F24C 15/006; H05B 6/642

(57) ABSTRACT

A ventilation system for an oven is provided. The system includes a rear duct assembly. The rear duct assembly includes vertical walls defining a vertical air flow path along a rear of the oven, and a separator plate dividing the vertical air flow path into a first air flow configured to receive air from oven electronics and a second air flow configured to receive air from an oven cavity. The separator plate extends vertically downward between the vertical walls from the top of the vertical air flow path a portion of the height of the oven until a mixing zone at the rear of the oven into which the first and second air flows combine into a combined air flow.

### CROSS-REFERENCE TO RELATED APPLICATIONS

This application claims foreign priority benefits under 35 U.S.C. § 119(a)-(d) to CN Application 202111226996.4 filed Oct. 21, 2021, the contents of which is hereby incorporated by reference in its entirety.

### TECHNICAL FIELD

Aspects of the disclosure relate to a high efficiency oven cavity ventilation system having improved air flow.

### BACKGROUND

Heat is generated by the magnetron and other components of a microwave oven. To cool these components, the oven draws in cool air and blows that air over the components. The oven may also blow air through the oven cavity to carry away heat and smells produced within the oven cavity. This process also allows for condensation to be carried away and out of the oven.

### SUMMARY

In one or more illustrative examples, a ventilation system for an oven is provided. The system includes a rear duct assembly. The rear duct assembly includes vertical walls defining a vertical air flow path along a rear of a cavity wrapper of the oven and a separator plate dividing the vertical air flow path into a first vertical chamber configured to receive a first air flow from oven electronics and a second vertical chamber configured to receive a second air flow from an oven cavity. The separator plate extends vertically downward between the vertical walls from the top of the vertical air flow path for a portion of a height of the oven until a mixing zone at the rear of the oven into which the first and second air flows combine into a combined air flow.

In some examples, a channel extends from the rear of the oven to the bottom front of the oven, where the channel is configured to receive the combined air flow to be exhausted out the front of the oven. In some examples, the cavity wrapper defines an air outlet through the top rear surface of the oven cavity, and a cavity wrapper top cap is included that is configured to direct the second air flow from the air outlet of the oven cavity into the rear duct assembly.

In some examples, insulation is formed to surround the top, bottom, side, and back walls of the cavity wrapper to reduce heat losses from the oven cavity, wherein the insulation defines a slot to hold the cavity wrapper top cap in place to permit passage of the air flow from the air outlet. In some examples, one or more humidity sensors are located in the second air flow configured to measure humidity of the second air flow before the mixing zone.

In some examples, a fan is configured to drive the first air to draw this heat away from the oven electronics. In some examples, the oven electronics include one or more of a magnetron, a transformer, a capacitor, and an electronics board.

In one or more illustrative examples, a ventilating oven is provided. The oven includes oven electronics, a cavity wrapper defining an oven cavity, the oven cavity having an access opening and walls at the top, left side, right side, back, and bottom; and a rear duct assembly. The rear duct assembly includes vertical walls defining a vertical air flow path along the back of the cavity wrapper, and a separator plate dividing the vertical air flow path into a first vertical chamber configured to receive a first air flow from the oven electronics and a second vertical chamber configured to receive a second air flow from the oven cavity. The separator plate extends vertically downward between the vertical walls from the top of the vertical air flow path for a portion of a height of the oven until a mixing zone at the rear of the oven into which the first and second air flows combine into a combined air flow.

In some examples, a channel extends from the rear of the oven to a bottom front of the oven, the channel configured to receive the combined air flow to be exhausted out the front of the oven. In some examples, the cavity wrapper defines an air outlet through a top rear surface of the oven cavity, and further comprising a top cap of the cavity wrapper configured to direct the second air flow from the air outlet of the oven cavity into the rear duct assembly.

In some examples, insulation is formed to surround top, bottom, side, and back walls of the cavity wrapper to reduce heat losses from the oven cavity, wherein the insulation defines a slot to hold the top cap of the cavity wrapper in place to permit the passage of the second air flow from the air outlet. In some examples, one or more humidity sensors are located in the second air flow configured to measure humidity of the second air flow before the mixing zone.

In some examples, a fan is configured to drive the first air to draw heat away from the oven electronics. In some examples, the oven electronics include one or more of a magnetron, a transformer, a capacitor, and an electronics board.

In one or more illustrative examples, a method for ventilating an oven is provided. A first air flow is received from oven electronics into a first vertical chamber of a vertical air flow path along a rear of a cavity wrapper of an oven. A second air flow is received from an oven cavity into a second vertical chamber of the vertical air flow path, the first and second vertical chambers being defined by a separator plate extending vertically downward between vertical walls from a top of the vertical air flow path for a portion of a height of the oven until a mixing zone at the rear of the oven. The first and second air flows are combined, in the mixing zone, into a combined air flow.

In some examples, the combined air flow is received into a channel extending from the rear of the oven to a bottom front of the oven and the combined air flow is exhausted out a front vent of the oven. In some examples, a top cap is utilized for directing the second air flow from an air outlet defined through a top rear surface of a cavity wrapper into a rear duct assembly.

In some examples one or more humidity sensors located in the second air flow are utilized to measure humidity of the second air flow before the mixing zone. In some examples, a fan is utilized to drive the first air to draw heat away from the oven electronics.

In one or more illustrative examples, A ventilation system for an oven is provided. A rear duct, having at least side and rear walls, defines a generally vertical channel, the channel having an upper end and a lower end. The upper end of the channel is configured to direct, in a downward direction, a first air flow received from an oven cavity, the lower end of the rear duct being configured to provide at least the first air flow into a bottom channel below the oven cavity. The rear duct further defines a series of air inlets along one of the side walls of the channel, the air inlets being open to a second air flow from oven electronics, the second air flow flowing vertically downward adjacent to the series of air inlets. The first air flow and a first portion of the second air flow mixes within the channel in a first mixing zone to form a partially mixed air flow. A remainder portion of the second air mixes with the partially mixed air flow in a second mixing zone to form a combined airflow.

In some examples, the lower end of the rear duct defines a deflector portion configured to redirect the first air flow from the downward direction into a horizontal airflow to be received by the bottom channel.

In some examples, each of the air inlets defines a louver extending outward and vertically upward from the side of the channel, the louvers being configured to direct the portion of the second air flow into the channel.

### BRIEF DESCRIPTION OF THE DRAWINGS

FIG. 1 is a perspective view of a cutaway of the microwave oven, in accordance with one or more embodiments of the disclosure;

FIG. 2 is a plan view of a cutaway of the microwave oven, in accordance with one or more embodiments of the disclosure;

FIG. 3 is an exploded view of components of the microwave oven, in accordance with one or more embodiments of the disclosure;

FIG. 4 is a view of a cutaway of the microwave oven illustrating the magnetron and cavity air flows, in accordance with one or more embodiments of the disclosure;

FIG. 5 is a view of a cutaway of the microwave oven illustrating the mixing zone, in accordance with one or more embodiments of the disclosure;

FIG. 6 is a view of a cutaway of the microwave oven illustrating the sensor locations and detail of the cavity top cap, in accordance with one or more embodiments of the disclosure.

FIG. 7 is a side view of a cutaway of the microwave oven in an alternative embodiment illustrating a multiple-inlet rear duct having an alternative design;

FIG. 8 is a rear view of a cutaway of the microwave oven in the alternative embodiment illustrating the multiple-inlet rear duct having an alternative design; and

FIG. 9 is a detail of a multiple-inlet rear duct having a different design.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Ovens employ ventilation systems to relieve the heat generated by the magnetron and other oven components. Ventilation systems are also used to extract excess moisture from the oven cavity. Such systems typically include one or more fans to promote air flow and channels to guide the air flow from the oven to the external environment. The efficiency of such systems depends in part on the quantity of bends in the ventilation channels, as each bend may increase turbulence and reduce air flow pressure. Moreover, the cost of such systems may increase with part count.

As described in detail herein, an improved cavity ventilation system for a microwave includes a vertical flow path along the back of the oven. A cavity air flow may exit the oven cavity via cavity exhaust holes at the top of the cavity wrapper. The cavity air flow may traverse the vertical flow path down the back of the oven. Slots may be cut into the oven insulation and a top cover may be inserted into the slot to guide the cavity air flow towards the back of the oven. A magnetron air flow may also traverse the vertical flow path down the back of the oven. The oven may include a vertical separation plate along the vertical flow path to differentiate the cavity air flow from the magnetron air flow until a mixing zone at the mid-lower rear of the oven. Sensors may be located in the cavity air flow path along the oven rear. These sensors may include humidity sensors.

This design provides for an improved cavity exhaust flow with a minimum of bends, allowing for both ease of manufacture and lower system air resistance with a streamlined vertical flow. Moreover, the design provides for reduced cost by eliminating the use of side duct apparatus. Further the design provides a sensor region defined to achieve consistent reading for sensors and other measuring instruments. Further aspects of the ventilation system are described in detail herein.

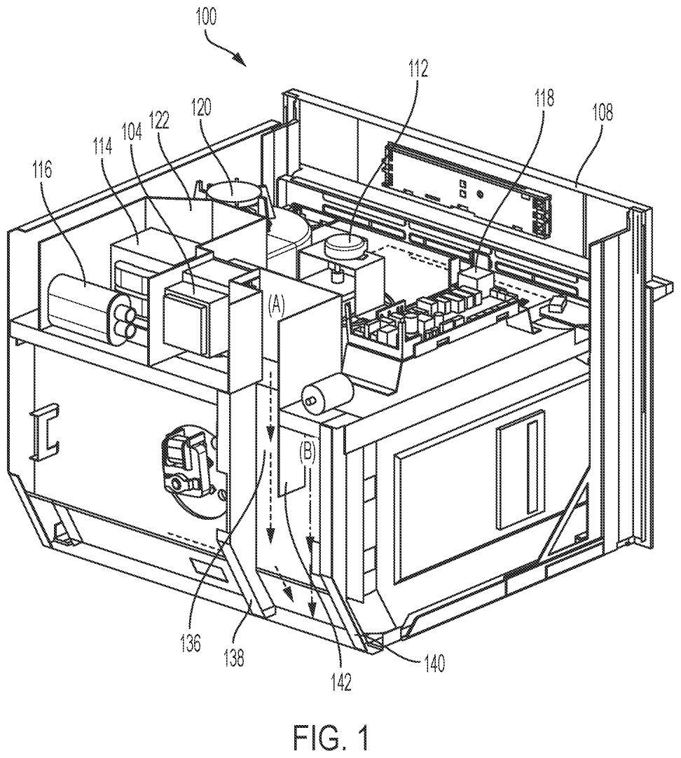

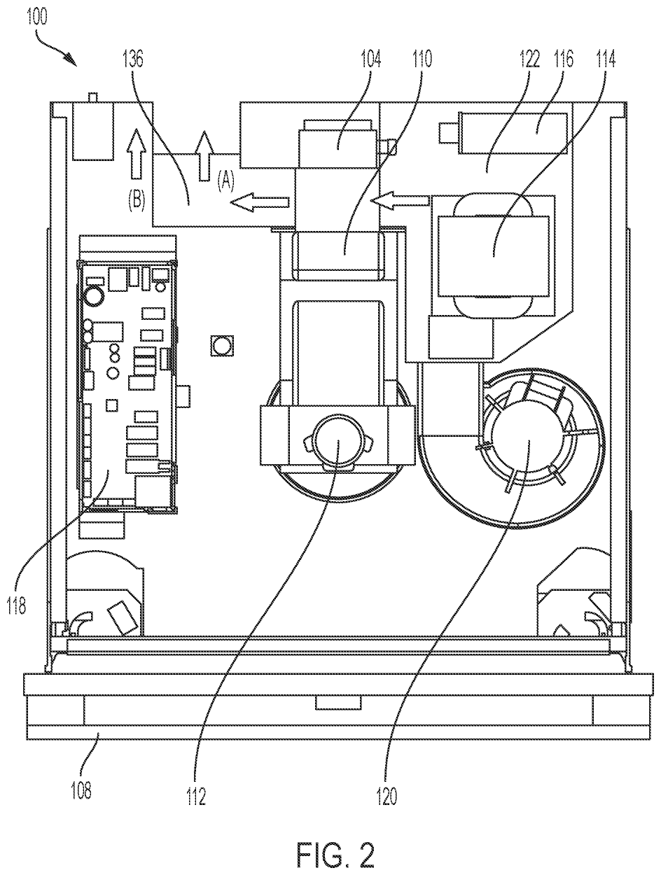

FIGS. 1-6 collectively illustrate aspects of an oven 100 implementing an improved ventilation system. In general, the oven 100 may cook food placed into an oven cavity 102 by exposing the food to electromagnetic radiation in the microwave frequency range. This radiation is produced by a magnetron 104, where electrons are emitted from a hot cathode to resonant cavities of the anode at speeds that generate the microwave energy.

The oven 100 includes a cavity wrapper 106 that defines an access opening and walls at the top, left side, right side, back and bottom. A door 108 may be arranged at a front of the oven cavity 102 to selectively cover the access opening. The door 108 may operate to move between an open position where the oven cavity 102 is accessible via the access opening and a closed position where the door 108 seals the opening. The cavity wrapper 106 may be made of a material such as stainless steel or ceramic enamel, to prevent the passage of the radiation outside of the oven cavity 102. The door 108 may include a clear window for observing the food, shielded by a metal mesh to prevent the passage of the radiation.

To perform a cooking cycle, the food is placed in the oven cavity 102, the door 108 is closed, and the magnetron 104 is activated. During operation, microwave energy travels from the magnetron 104 through a waveguide 110 and is distributed into the oven cavity 102 via a mode stirrer 112. The microwave energy transfers to the food via dielectric heating. Once the food is heated, the magnetron 104 is deactivated, the door 108 is reopened, and the food is removed. The oven 100 may also include a door switch (not shown) that detects whether the door 108 is open or closed, such that the magnetron 104 is automatically deactivated should the door 108 be opened during a cooking cycle.

The magnetron 104 may be driven by electrical components that provide a high voltage source, such as a transformer 114 and capacitor 116 as shown (in other examples a switching power supply may be used). The oven 100 may also include an electronics board 118 to control the operation of the other components of the oven 100. During operation of the oven 100, these electrical components of the oven 100 (e.g., the magnetron 104, transformer 114, capacitor 116, and electronics board 118) produce waste heat. To remove this heat, the oven 100 may include a fan 120 driving an air flow into a top air duct 122 to draw this heat away from the electrical components. This magnetron air flow is illustrated herein as air flow (A).

Additionally, because the oven 100 operates by heating water molecules, the cooking process tends to generate steam. This steam may condense on the cooler inside surfaces of the oven cavity 102. This condensation may be more prevalent when cooking foods of high moisture content for extended periods of time. In these instances, the condensation may be especially noticeable to the user. Thus, in addition to cooling the magnetron 104, an oven cavity air flow may be used to carry away the condensation, as well as providing an air flow circulation into the oven cavity 102 (e.g., for condensation management, odor reduction, heat management, etc.). This oven cavity air flow is illustrated herein as air flow (B).

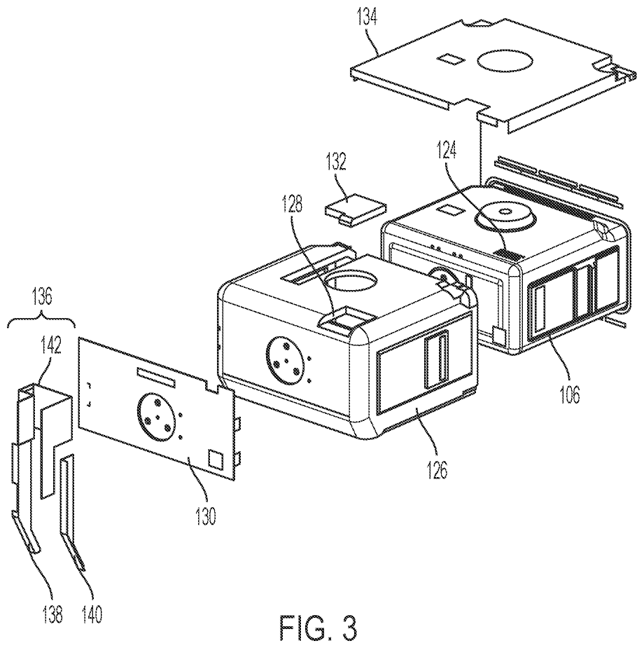

As illustrated in FIG. 3, the cavity wrapper 106 defines an air outlet 124 extending through the top rear surface of the oven cavity 102 through which the oven cavity air flow (B) originates from the oven cavity 102. Foam or another type of insulation 126 may be formed to surround the top, bottom, side, and back walls of the cavity wrapper 106 to reduce heat losses from the oven cavity 102. The insulation 126 may define a slot 128 to permit passage of the air flow (B) from the air outlet 124.

A back plate 130 may be formed from sheet metal or another suitable material and may be installed behind the rear of the insulation 126. The back plate 130 may serve to protect and shield the rear outer surface of the insulation 126. A cavity wrapper top cap 132 may be placed into the slot 128 to direct the air flow (B) exiting the air outlet 124 rearwards towards the back of the oven 100 and then downwards behind the back plate 130. A top plate 134 may be formed from sheet metal or another suitable material and may be installed above the insulation 126 and cavity wrapper top cap 132.

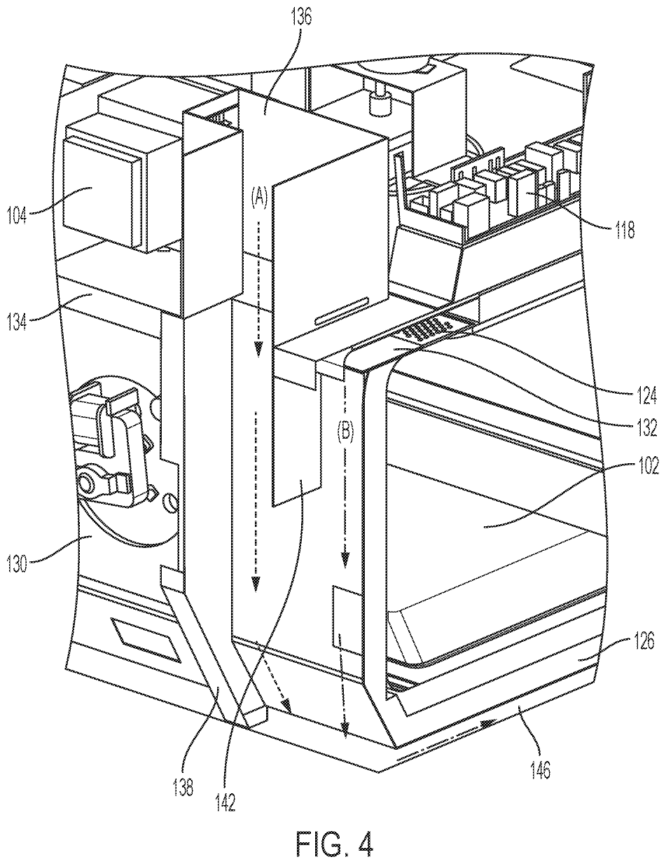

A rear duct assembly 136 may be installed behind the back plate 130 to define a vertical air flow path down the rear of the oven 100. As shown more clearly in FIG. 4, first and second vertical walls 138, 140 extend rearward from the back plate 130 and, along with the rear face of the back plate 130 collectively define a vertical channel extending the vertical height of the oven 100. While not shown, the exterior shell of the oven 100 may complete the enclosure of the back face of the vertical air flow path.

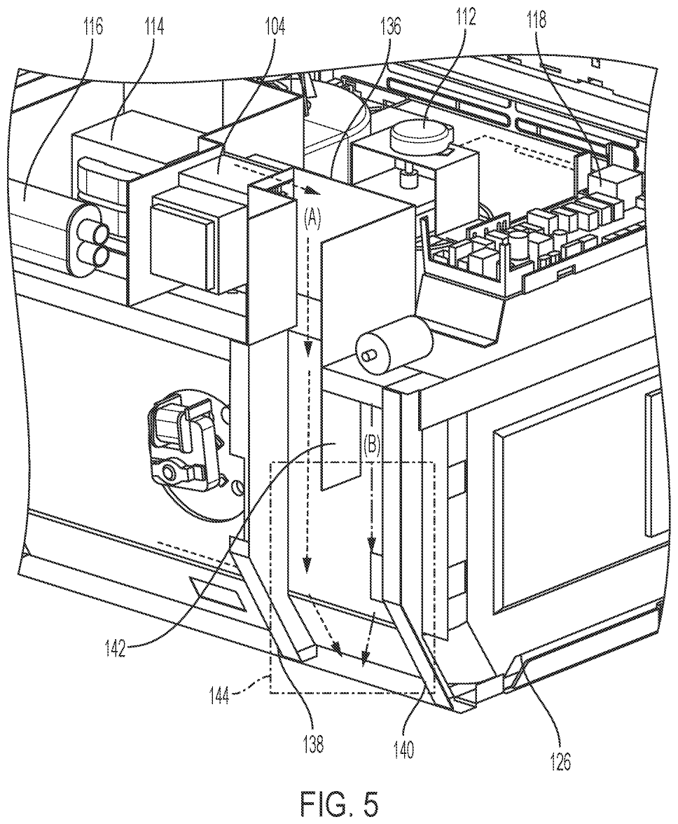

A separator plate 142 of the rear duct assembly 136 may extend vertically downward between the first and second vertical walls 138, 140 to divide the upper portion of the vertical channel into two vertical chambers. The separator plate 142 may be formed of sheet metal, plastic, or another suitable material. For instance, the separator plate 142 may extend to the middle height or lower of the vertical height of the oven 100. A mixing zone 144 may be defined at the mid-lower rear of the vertical air flow path, below the separator plate 142 and between the first and second vertical walls 138, 140. This mixing zone 144 is most clearly shown in FIG. 5. In many examples, the mixing zone 144 may begin midway down the oven 100 or between midway and before the bottom of the oven 100. This allows for the mixing of the air flows (A) and (B) to occur at the rear of the oven 100, before the air flow reaches the bottom of the oven 100.

During operation of the oven 100, the fan 120 may be activated to force air into top air duct 122. This air flow (A) may pass over the magnetron 104, transformer 114, capacitor 116, and/or other electrical components of the oven 100 to relieve the heat generated by those components. The rear duct assembly 136 may receive the air flow (A) having passed over components into an upper end of a first of the two vertical chambers.

Additionally during the operation of the oven 100, the rear duct assembly 136 may receive the air flow (B) exiting the cavity wrapper top cap 132 into an upper end of the other of the two vertical chambers. In some examples, the air flow (B) may passively flow out of the air outlet 124 of the oven cavity 102 due to heated air rising as a result of cooking operations taking place in the oven cavity 102. This air flow (B) out of the oven cavity 102 may also be encouraged due to the air flow (A) pulling air downward through the rear duct assembly 136. In another example, the fan 120 (or another fan) may provide fresh air into the oven cavity 102 which may force the air flow (B) to exit out the air outlet 124 of the oven cavity 102.

The separator plate 142 may serve to maintain separation of the air flows (A) and (B) passing through two upper chambers of the rear duct assembly 136 until the mixing zone 144. In the mixing zone 144, the cavity air flow (B) and the main air flow (A) exit the first and second vertical chambers and combine to form a combined air flow. The combined air flow then passes towards the bottom of the oven 100 and through a bottom channel 146 extending from the rear of the oven 100 to the bottom front of the oven 100 as shown in FIG. 4. The combined air flow may then exhaust out of the bottom channel 146 of the oven 100 via front vents (not shown).

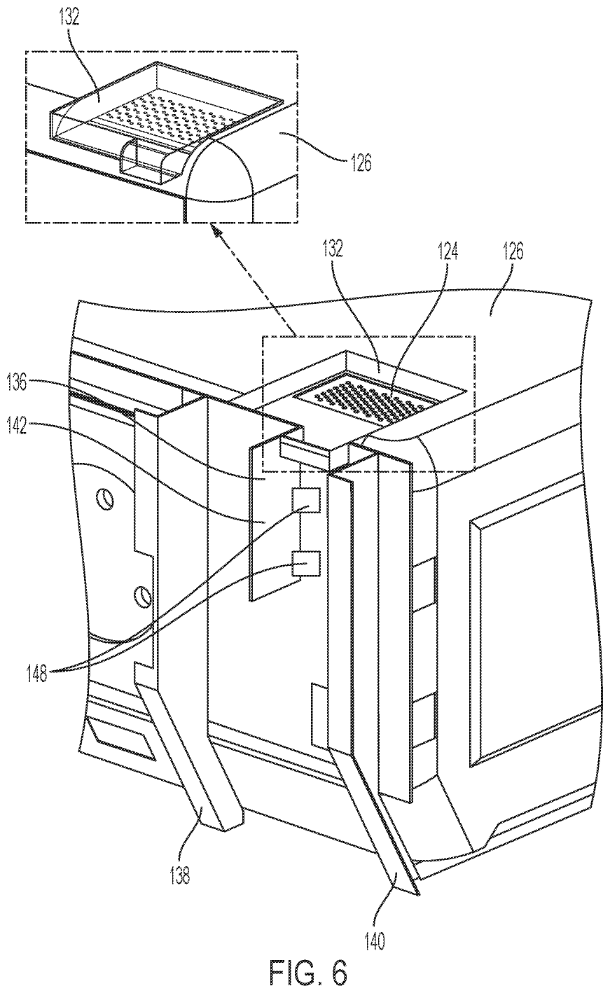

Because of the separation provided by the separator plate 142, as shown in FIG. 6 one or more sensors 148 may be placed in the rear duct assembly 136 to separately monitor various parameters of the air flows (A) and (B). In an example, humidity sensors 148 may be placed in the air flow (B) upstream from the mixing zone 144. This may allow for the humidity of the air flow (B) to be measured independent of the parameters of the air flow (A).

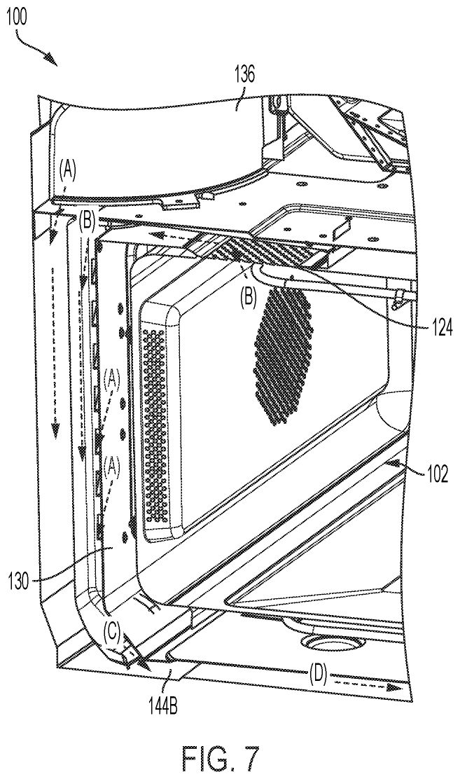

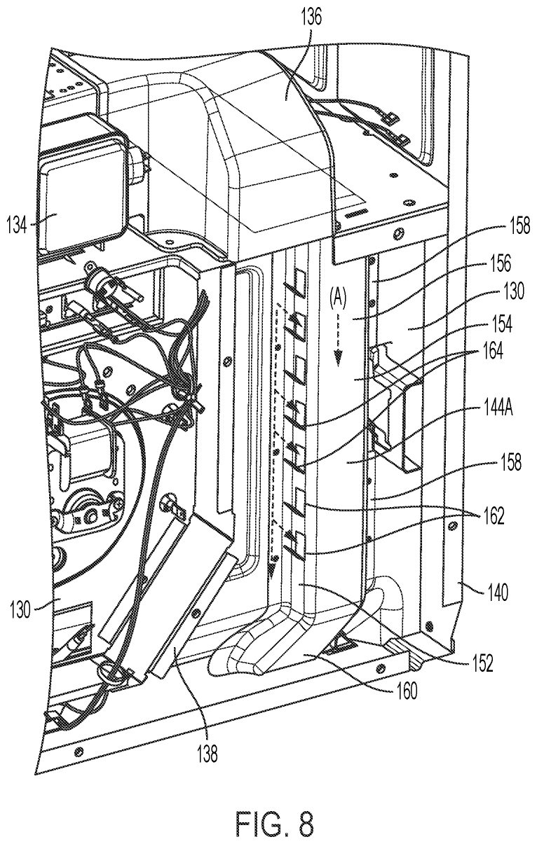

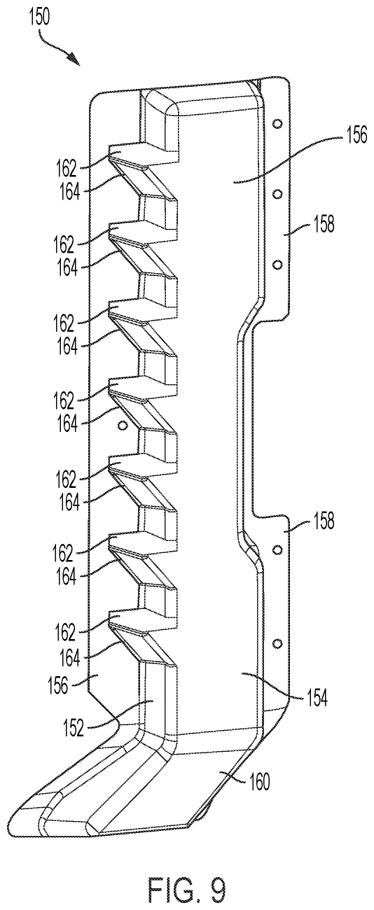

FIG. 7 is a side view of a cutaway of the microwave oven 100 in an alternative embodiment having a multiple-inlet rear duct 150. FIG. 8 is a rear view of a cutaway of the microwave oven 100 in the alternative embodiment illustrating the multiple-inlet rear duct 150. FIG. 9 is a detail of the multiple-inlet rear duct 150 having a different design.

Similar to the first and second vertical walls 138, 140 illustrated in FIG. 4, the rear duct 150 may have at least side walls 152 and a rear wall 154 defining a generally vertical channel 156. The channel 156 may be provided to direct airflow received from the air outlet 124 at the top of the oven cavity 102 downward, behind the oven cavity 102, to the bottom channel 146 below the oven cavity 102. When installed, the upper end of the rear duct 150 may be in fluid communication with the air outlet 124. This may allow the rear duct 150 to receive the air flow (B) exiting the oven cavity 102. In an example, the rear duct 150 may be formed of stamped sheet metal or another suitable material.

The lower end of the channel 156 may define a curved or angled deflector portion 160. The deflector portion 160 may be configured to redirect the vertical air flow from the downward direction in the channel 156 into a horizontal airflow to be received by the bottom channel 146. The horizontal airflow may then proceed out the front of the oven 100. The rear duct 150 may further define one or more flanges 158 including apertures or other features facilitating mounting of the rear duct 150 onto the rear of the back plate 130.

The rear duct 150 may further define a series of air inlets 162 along a side wall 152 of the channel 156. The air inlets 162 may be open to air flowing vertically downward adjacent to the rear duct 150. Each air inlet 162 may define a louver 164 extending outward and vertically upward from the side of the channel 156 to direct a portion of the adjacent downward airflow into the channel 156. In one possibility, cutout features may be punched or cut into the side wall 152 of the channel 156, e.g., as three sides of a rectangle, with the fourth lower side remaining connected to the rear duct 150, such that the cutout may then be bent outwards from the connected lower side. In other examples, as shown in FIG. 9, the air inlets 162 may be formed as an integral portion of the side wall 152 of the channel 156 itself.

As discussed above, during operation of the oven 100, the electrical components of the oven 100 such as the magnetron 104, transformer 114, capacitor 116, and electronics board 118 may produce waste heat. To remove this heat, the oven 100 may utilize the fan 120 for driving air flow into a top air duct 122 to draw this heat away from the electrical components. This flow from the ventilation system is illustrated in FIGS. 7-9 as air flow (A).

As best seen in FIG. 8, the air flow (A) from the ventilation system may flow down the rear of the oven 100, in a bounded area between the rear duct 150 and the vertical wall 138. Thus, the air flow (A) may proceed adjacent to the rear duct 150, from the oven 100 electronics area above the oven cavity 102 to the bottom of the oven 100 below the oven cavity 102. The air flow (A) may then continue through the bottom channel 146 from the rear of the oven 100 to the bottom front of the oven 100 and out of the oven 100.

Additionally, the oven cavity 102 air flow (B) may exit from the oven cavity 102 using the air outlet 124 located on the top of the oven cavity 102. This air flow (B) typically may exit at a high temperature and humidity. The air flow (B) from the oven cavity 102 may flow into the upper end of the rear duct 150, travel down the rear duct 150 and be addressed into the bottom channel 146 by the angled deflector portion 160. The rear duct 150 may accordingly connect the chimney outlet section between the top of the oven cavity 102 and the bottom of the upper electronics area with the bottom channel 146 below the oven cavity 102.

The air inlets 162 along the rear duct 150 may serve to connect the air flow (A) from the ventilation system to the air flow (B) from the oven cavity 102, resulting in a first air mixing in a first mixing zone 144A inside the rear duct 150. The first mixing zone 144A between the two flows (A) and (B) allows a temperature reduction of the air flow (B) from the oven cavity 102 within the rear duct 150 and a humidity reduction as well. This combined airflow may be referred to as a partially mixed air flow (C).

A second air mixing occurs at a second mixing zone 144B in the region at the outlet section of the rear duct 150. Here, the first mixed air flow (C) from the oven cavity 102 combines with the reminder of the air flow (A) from the ventilation system that is not already mixed into the partially mixed air flow (C). These air flows (A) and (C) are joined and addressed into the bottom channel 146, resulting in combined air flow (D). The combined air flow (D) may then continue through the bottom channel 146 and out the front of the oven 100.

Thus, an improved oven ventilation system is provided. The air outlet 124 on the top of the cavity wrapper 106 allows an air flow (B) to escape the oven cavity 102 easily without traversing bends. Additionally, the air flow (A) coming from the magnetron 104 powered via the fan 120 forces the incoming cavity air flow (B) into a downward direction to exit the oven 100 via bottom outlet vents. In some embodiments, the separator plate 142 allows for the differentiation of the cavity air flow (B) from the magnetron air flow (A) until the mixing zone 144, providing for the placement of sensors 148 to separately measure the air flows. Or, in other embodiments, the rear duct 150 provides a path for the controlled mixing of the cavity air flow (B) with a portion of the magnetron air flow (A) in a first mixing zone 144A, along with a further mixing of the first mixed air flow (C) with the reminder of the air flow (A) in a second mixing zone 144B to produce the combined air flow (D). These ventilation systems provide greater efficiency than other systems due to the minimization of bends in the ventilation channels that could increase turbulence and reduce air flow pressure. Moreover, the cost of the improved ventilation system may be reduced compared to side-venting systems requiring a greater part count.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A ventilation system for an oven, comprising:
a rear duct assembly, including
vertical walls defining a vertical air flow path along a rear of a cavity wrapper of the oven, and
a separator plate dividing the vertical air flow path into a first vertical chamber configured to receive a first air flow from oven electronics and a second vertical chamber configured to receive a second air flow from an oven cavity,
wherein the separator plate extends vertically downward between the vertical walls from the top of the vertical air flow path for a portion of a height of the oven until a mixing zone at the rear of the oven into which the first and second air flows combine into a combined air flow.

2. The ventilation system of claim 1, further comprising a channel extending from the rear of the oven to a bottom front of the oven, the channel configured to receive the combined air flow to be exhausted out the front of the oven.

3. The ventilation system of claim 1, wherein the cavity wrapper defines an air outlet through a top rear surface of the oven cavity, and further comprising a top cap of the cavity wrapper configured to direct the second air flow from the air outlet of the oven cavity into the rear duct assembly.

4. The ventilation system of claim 3, further comprising insulation formed to surround top, bottom, side, and back walls of the cavity wrapper to reduce heat losses from the oven cavity, wherein the insulation defines a slot to hold the top cap of the cavity wrapper in place to permit passage of the second air flow from the air outlet.

5. The ventilation system of claim 1, further comprising one or more humidity sensors located in the second air flow configured to measure humidity of the second air flow before the mixing zone.

6. The ventilation system of claim 1, further comprising a fan configured to drive the first air flow to draw this heat away from the oven electronics.

7. The ventilation system of claim 1, wherein the oven electronics includes one or more of a magnetron, a transformer, a capacitor, and an electronics board.

8. A ventilating oven, comprising:
oven electronics;
a cavity wrapper defining an oven cavity, the oven cavity having an access opening and walls at the top, left side, right side, back, and bottom; and
a rear duct assembly, including
vertical walls defining a vertical air flow path along the back of the cavity wrapper, and
a separator plate dividing the vertical air flow path into a first vertical chamber configured to receive a first air flow from the oven electronics and a second vertical chamber configured to receive a second air flow from the oven cavity,
wherein the separator plate extends vertically downward between the vertical walls from the top of the vertical air flow path for a portion of a height of the oven until a mixing zone at the rear of the oven into which the first and second air flows combine into a combined air flow.

9. The oven of claim 8, further comprising a channel extending from the rear of the oven to a bottom front of the oven, the channel configured to receive the combined air flow to be exhausted out the front of the oven.

10. The oven of claim 8, wherein the cavity wrapper defines an air outlet through a top rear surface of the oven cavity, and further comprising a top cap of the cavity wrapper configured to direct the second air flow from the air outlet of the oven cavity into the rear duct assembly.

11. The oven of claim 10, further comprising insulation formed to surround top, bottom, side, and back walls of the cavity wrapper to reduce heat losses from the oven cavity, wherein the insulation defines a slot to hold the top cap of the cavity wrapper in place to permit passage of the second air flow from the air outlet.

12. The oven of claim 8, further comprising one or more humidity sensors located in the second air flow and configured to measure humidity of the second air flow before the mixing zone.

13. The oven of claim 8, further comprising a fan configured to drive the first air flow to draw heat away from the oven electronics.

14. The oven of claim 8, wherein the oven electronics includes one or more of a magnetron, a transformer, a capacitor, and an electronics board.

15. A method for ventilating an oven, comprising:
receiving a first air flow from oven electronics into a first vertical chamber of a vertical air flow path along a rear of a cavity wrapper of an oven;
receiving a second air flow from an oven cavity into a second vertical chamber of the vertical air flow path, the first and second vertical chambers being defined by a separator plate extending vertically downward between vertical walls from a top of the vertical air flow path for a portion of a height of the oven until a mixing zone at the rear of the oven; and
combining, in the mixing zone, the first and second air flows into a combined air flow.

16. The method of claim 15, further comprising:
receiving the combined air flow into a channel extending from the rear of the oven to a bottom front of the oven; and
exhausting the combined air flow out a front vent of the oven.

17. The method of claim 15, further comprising utilizing a top cap for directing the second air flow from an air outlet defined through a top rear surface of a cavity wrapper into a rear duct assembly.

18. The method of claim 15, further comprising utilizing one or more humidity sensors located in the second air flow to measure humidity of the second air flow before the mixing zone.

19. The method of claim 15, further comprising utilizing a fan to drive the first air flow to draw heat away from the oven electronics.

20. A ventilation system for an oven, comprising:
a rear duct, having at least side and rear walls defining a generally vertical channel, the channel having an upper end and a lower end,
the upper end of the channel being configured to direct, in a downward direction, a first air flow received from an oven cavity,
the lower end of the rear duct being configured to provide at least the first air flow into a bottom channel below the oven cavity,
the rear duct further defining a series of air inlets along one of the side walls of the channel, the air inlets being open to a second air flow from oven electronics, the second air flow flowing vertically downward adjacent to the series of air inlets,
wherein the first air flow and a first portion of the second air flow mixes within the channel in a first mixing zone to form a partially mixed air flow, and a remainder portion of the second air mixes with the partially mixed air flow in a second mixing zone to form a combined airflow.

21. The ventilation system of claim 20, wherein the lower end of the rear duct defines a deflector portion configured to redirect the first air flow from the downward direction into a horizontal airflow to be received by the bottom channel.

22. The ventilation system of claim 20, wherein each of the air inlets defines a louver extending outward and vertically upward from the side of the channel, the louvers being configured to direct the portion of the second air flow into the channel.
